(19) United States
(12) Patent Application Publication
(10) Pub. No.: US 2008/0200211 A1
(43) Pub. Date: Aug. 21, 2008

(54) SYSTEM AND METHOD FOR FORMING CELL BY USING DISTRIBUTED ANTENNAS IN WIMAX MOBILE COMMUNICATION SYSTEM

(76) Inventors: Seong-Taek HWANG, Pyeongtaek-si (KR); Shuangfeng Han, Suwon-si (KR); Chunhui Zhou, Beijing (CN); Jing Wang, Beijing (CN); Ming Zhao, Beijing (CN); Zheng Xu, Beijing (CN)

Correspondence Address: CHA & REITER, LLC, 210 ROUTE 4 EAST STE 103, PARAMUS, NJ, 07652, US

(21) Appl. No.: 12/034,713

(22) Filed: Feb. 21, 2008

(30) Foreign Application Priority Data
Feb. 21, 2007 (KR) 2007-17442

(51) Int. Cl. H04M 1/00

(52) U.S. Cl. 455/562.1

(57) ABSTRACT

A system and a method for forming a cell by using distributed antennas in a World interoperability for Microwave Access (WiMAX) mobile communication system supporting a broadband wireless access communication system. A virtual cell is formed with a specific Mobile Station (MS) as a central part of the virtual cell by using distributed antennas, which improves the transmission capacity and the performance of an overall network system without changing the structure of a backbone network and the interface of the overall network system. The system includes, multiple MSes; distributed antennas for perform simultaneous communications with at least one MS among the multiple MSes, and for forming one virtual cell by communicating with the multiple MSes; and a Base Station (BS), which is typically connected to the distributed antennas through optical fibers, for communicating with the MSes.

### CLAIM OF PRIORITY

This application claims the benefit under 35 U.S.C. §119(a) from an application entitled “System and Method for Forming Cell by Using Distributed Antennas in WiMAX Mobile Communication System,” filed in the Korean Intellectual Property Office on Feb. 21, 2007 and assigned Serial No. 2007-17442, the contents of which are hereby incorporated by reference in its entirety.

### BACKGROUND OF THE INVENTION

1. Field of the Invention

The present invention relates to a broadband wireless communication system. More particularly, the present invention relates to a system and a method that is suitable for forming a virtual cell in a World interoperability for Microwave Access (WiMAX) mobile communication system.

2. Description of the Related Art

In general, the WiMAX mobile communication system is based on Institute of Electrical and Electronics Engineers (IEEE) 802.16e Wireless Metropolitan Area Network (WMAN) standards ensuring mobility of the mobile stations (MS), and supports Broadband Wireless Access (BWA). A network structure supported by the IEEE 802.16 standards operates in two schemes, which typically includes a mesh scheme and the PMP scheme.

In some nations and regions, the WiMAX mobile communication system having the PMP structure is being used for testing purposes, and/or for commercial purposes. The WiMAX mobile communication system is worthy of close attention for future needs due to the favorable aspects of the system to provide high-speed data communications, with a maximum communication range, and relatively cheap costs. However, WiMAX also has problems that are adversely affecting its implementation because of the high costs associated with the installation of hot zones, each of which functions as a wireless Local Area Network (LAN) base station (BS) for relaying radio waves so as to meet multiple MSes of users and their frequent movements. Accordingly, the installation of such hot zones has been limited to concentrating in populous areas that would provide access for a relatively number of users, such as a crowded downtown, or a university library.

Therefore, with respect to the hot zones, possible changes such as using Multiple Input Multiple Output (MIMO) or cell division technology can accelerate the growth of WiMAX.

In relation to this technology, FIG. 1 is a view illustrating a conventional Single Input Single Output (SISO) system including a Base Station (BS) equipped with one antenna and multiple Mobile Stations (MSes), and FIG. 2 is a view illustrating an embodiment of a conventional MIMO system including a BS equipped with multiple antennas and multiple MSes each of which has one antenna. FIGS. 1 and 2 respectively show a backbone 101, 201, Access Control Router (ACR) 102,202, base station (BS) 103,203 and a plurality of MSs 104,204 within each cell/hot zone/transmission/area 105,205.

As illustrated in FIGS. 1 and 2, technology in which one or more antennas are not only established at a BS 103, but also one or more antennas are set up at a MS 104, has been previously proposed. The proposed technology improves the capacity of an overall network system, as well as transmission reliability, by using spatial diversity and spatial multiplexing.

However, while a MIMO scheme, (such as shown in FIG. 2) increases a data transfer rate and reduces errors theoretically in proportion to the number of antennas, drawbacks are raised in that the complexity of data transmission processing and consumption of channel resources also increases enormously, and due to near-far effect, the average capacity in a cell considerably varies according to a geographical position of a mobile communication MS.

FIG. 3 is view illustrating a conventional cellular system in which a cell is divided into multiple subcells. As can be seen with regard to FIG. 3, the technology of reducing the control range of each cell with an increase in the number of cells through the technology of cell division causes the required transmission output of the BSs to be reduced, and the capacity of an overall network system appears to increase because of the decrease of average access distance.

However, with regard to FIG. 3, as the sizes of cells or microcells become smaller due to the cell division process, there can actually be a reduction in capacity of an overall network system caused by a side effect of co-channel interference. Moreover, the increasing number of BSes and frequent handover operations increase system costs and a control load of an upper layer.

### SUMMARY OF THE INVENTION

Accordingly, the present invention has been made in part to solve at least some of the above-stated problems occurring in the prior art. The present invention provides a system and a method for forming a cell by using distributed antennas in a WiMAX mobile communication system, which can improve the transmission capacity and the performance of an overall network system without changing the structure of a backbone network and the interface.

In accordance with an exemplary aspect of the present invention, there is provided a system for forming a cell by using distributed antennas in a World interoperability for Microwave Access (WiMAX) mobile communication system supporting broadband wireless access according to an embodiment of the present invention, which includes: multiple Mobile Stations (MSes); distributed antennas for performing simultaneous communications with at least one among the multiple MSes, and for forming one virtual cell by communicating with the multiple MSes; and a Base Station (BS), connected to the distributed antennas through optical fibers for communicating with the MSes.

In accordance with another exemplary aspect of the present invention, there is provided a method for forming a cell by using distributed antennas in a World interoperability for Microwave Access (WiMAX) mobile communication system supporting broadband wireless access communication system according to another embodiment of the present invention, including the steps of: making a search, by a Mobile Station (MS), for one or more distributed antennas satisfying the preset service quality in the same cell including one Base Station (BS); selecting one or more distributed antennas satisfying the service quality according to a result of the search; forming a virtual cell with the selected one or more distributed antennas; and accessing a BS located in a cell including the formed virtual cell to one or more distributed antennas located in the virtual cell, and performing communications therebetween.

### BRIEF DESCRIPTION OF THE DRAWINGS

The above and other exemplary features, aspects, and advantages of the present invention will become more apparent from the following detailed description taken in conjunction with the accompanying drawings, in which:

FIG. 1 is a view illustrating a conventional SISO system including a BS equipped with one antenna and multiple MSes;

FIG. 2 is a view illustrating a conventional MIMO system including a BS equipped with multiple antennas and multiple MSes each of which has one antenna;

FIG. 3 is a view illustrating a conventional cellular system in which a cell is divided into multiple subcells;

FIG. 4 is a view illustrating a system for forming a virtual cell based on distributed antennas according to an exemplary embodiment of the present invention;

FIG. 5 is a view illustrating a virtual cell in a Distributed Wireless Communication System (DWCS) according to an exemplary embodiment of the present invention; and

FIG. 6 is a flowchart illustrating an example of the operation of a system for forming a virtual cell based on distributed antennas according to the present invention.

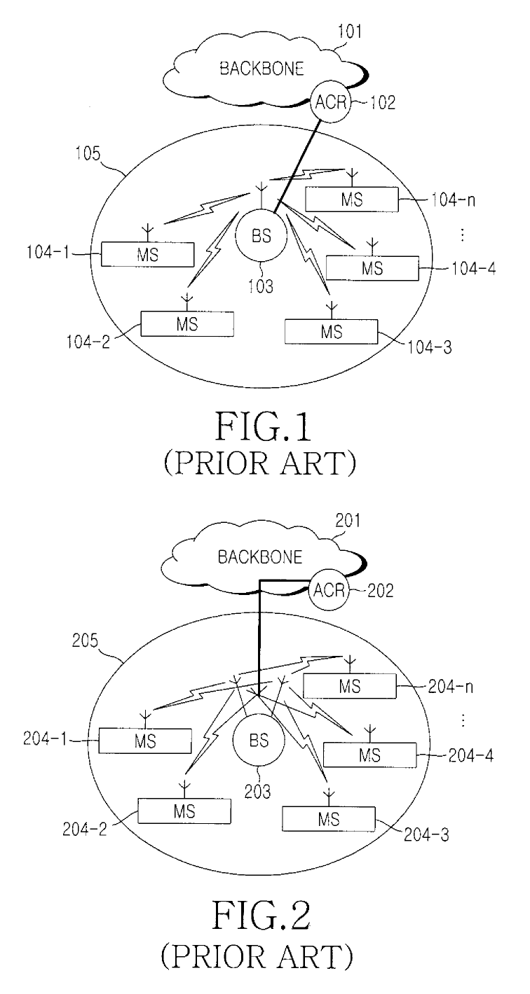

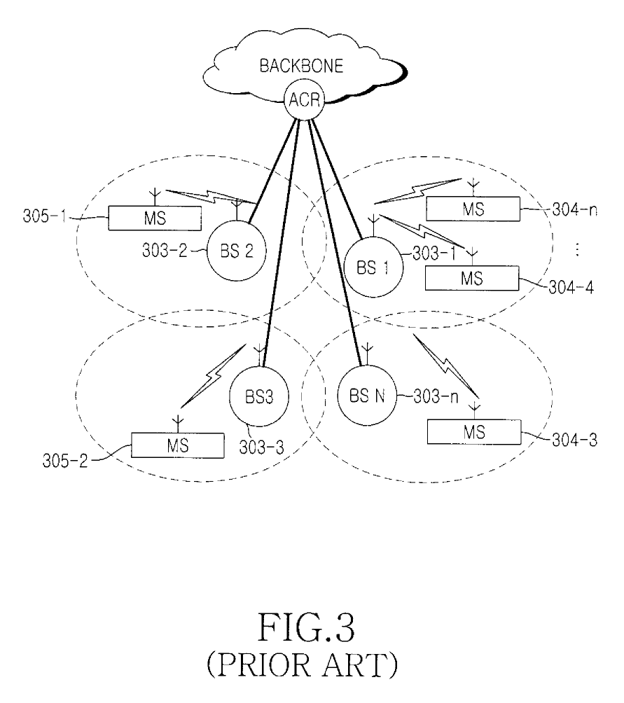

### DETAILED DESCRIPTION OF THE INVENTION

Hereinafter, exemplary embodiments of the present invention will be described in detail with reference to the accompanying drawings. It is to be understood that the present invention is not limited to the examples shown and described herein. The following description includes particulars, such as specific configuration elements, which are only presented in support of more comprehensive understanding of the present invention, and it will be obvious to those skilled in the art that prescribed changes in form and various modifications may be made to the particulars which does not depart from the spirit of the invention and the scope of the appended claims.

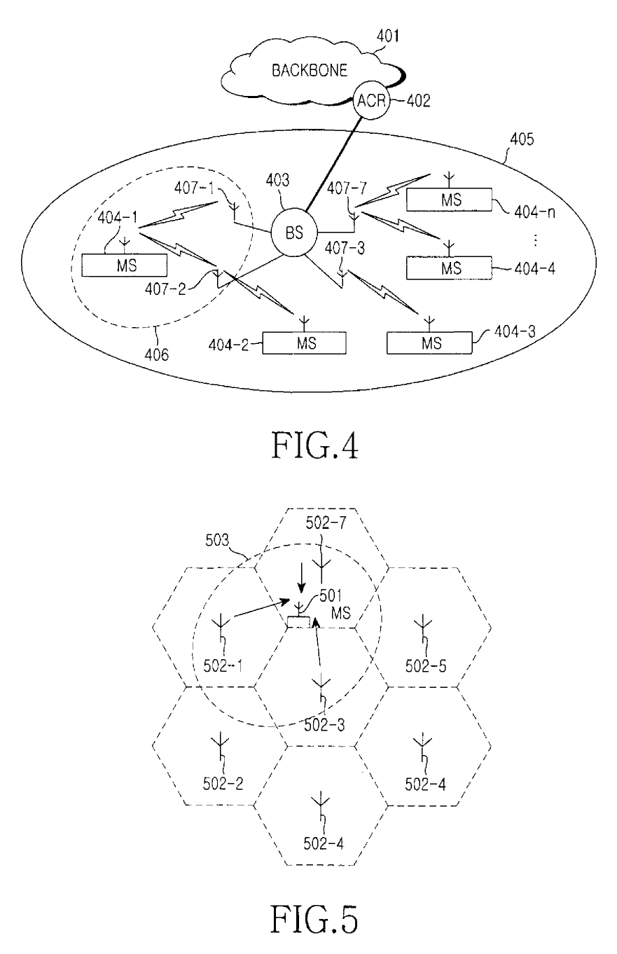

FIG. 4 illustrates an exemplary configuration of system for forming a virtual cell by using distributed antennas in a WiMAX mobile communication system according to the present invention. Referring to FIG. 4, a WiMAX mobile communication system related to an exemplary embodiment of the present invention includes a cell 405 having one or more distributed antennas 407-1 to n, a BS 403, multiple user MSes 404-1 to n, an Access Control Router (ACR) 402, and a backbone 401. Herein, the one or more distributed antennas 407-1 to n may communicate with at least one among the multiple user MSes 404-1 to n. The BS 403 is typically connected to the one or more distributed antennas 407 through optical fibers, and communicates with the multiple MSes 404. Each of the multiple user MSes 404 communicates with the BS via the distributed antennas, and describes the range of one cell. For example, the virtual cell is formed around the MS by communicating the MS (404 . . . n) with the distributed antennas. That is, since the virtual cell is formed by communicating the MS with the distributed antennas, the MS (404 . . . n) describes the range of the virtual cell.

Still referring to FIG. 4, the ACR 402 controls the BS 403. The backbone 401 receives data transmitted from the ACR 402, and performs a connection with another network.

More particularly, each of the MSes 404 performs communication with the BS 403 in order to gain access to a network system according to a request for a call connection and a channel condition in its located position. At this time, each of the MSes 404 can select one or more distributed antennas to which each of the MSes 404 can communicate while still satisfying optimal power and quality requirements (i.e., the service quality) of a signal in the range within the same cell where each MS is located, in order to receive communication services offered from the BS 403, or for a call connection with another MS. Also, the distributed antennas 407 equipped with a transceiver for performing conversion between a Radio Frequency (RF) signal and a digital Intermediate Frequency (IF) signal correspond to one or more distributed antennas located in the range where the distributed antennas 407 can communicate with the base station 403 for performing a transmitted digital IF signal processing.

Thus, the multiple MSes 404 communicate with one or more distributed antennas 407 belonging to the same BS, and the multiple distributed antennas 407 are connected to the BS 403, which in turn forms a cell corresponding to the range over which one BS can control.

Each of the multiple MSes 404 can search for and select one or more distributed antennas 407 so as to communicate with the BS 403 in its located place, and a point of reference on which the multiple MS 404 search for and select one or more distributed antennas 407 distributed over many places signifies one or more distributed antennas through which the multiple MScs 404 can perform communications at more than a preset received signal level.

Still referring to FIG. 4, according to an example of the present invention, at this time, within one cell 405 formed with the multiple MSes 404 and one or more distributed antennas 407 selected by the multiple MSes 404 as the central part of the cell, another virtual cell 406 is formed. Here, the virtual cell 406 is temporarily formed with a specific MS as the central part of the virtual cell 406 during only a time interval for which the specific MS communicates with the one or more distributed antennas 407 satisfying the service quality of the specific MS in a place where the specific MS is located. Then, even if the position of the specific MS changes, the specific MS searches for and selects one or more distributed antennas 407 satisfying the service quality in a place where the specific MS itself is located, and communicates with one or more distributed antennas 407. Herein, while performing the communications, at least another virtual cell can be formed.

According to an exemplary aspect of the present invention, the virtual cell 406 is always generated and ceases to exist in a place where each of the multiple MSes is located regardless of the movement of each of the multiple MSes. It causes, as illustrated in FIG. 5, a virtual cell to be formed with the specific MS as the central part of the virtual cell, and because the distributed antennas 502 can simultaneously communicate with one MS or multiple MSes adjacent to their area where the distributed antennas 502 can transmit/receive data, the distributed antennas 502 can be included in one or more virtual cells. Namely, each of the multiple MSes existing within the same cell forms a virtual cell for itself, and the virtual cell changes as the MS moves. Also, the BS 403 includes one or more virtual cells according to the number of MSes existing in the range of controllable cells. Furthermore, because the virtual cell exists within the same cell, and because a virtual cell is continuously produced in a current position as long as the MS communicates with the BS via the distributed antennas even if a position of the MA changes, a process of handover with usual meanings due to the movement between cells of the MS is not considered.

In addition, according to the present invention, the average access distance of a transmission output that the MS outputs for communications with the distributed antennas is reduced as the distributed antennas are set up in many distributed places, thereby more efficiently utilizing the electric power of the MS.

Moreover, in protocol layers of a WiMAX system according to the present invention, data processing is performed based on two layers, i.e. a physical layer and Media Access Control (MAC), included in a lower layer of an Open Systems Interconnection (OSI) standard reference model widely known in general in a communication system, and because a scheme of Orthogonal Frequency Division Multiple Access (OFDMA), duplexing technique, and the function of packet encapsulation also are not varied by the present invention. Therefore, a more detailed description of same will be omitted.

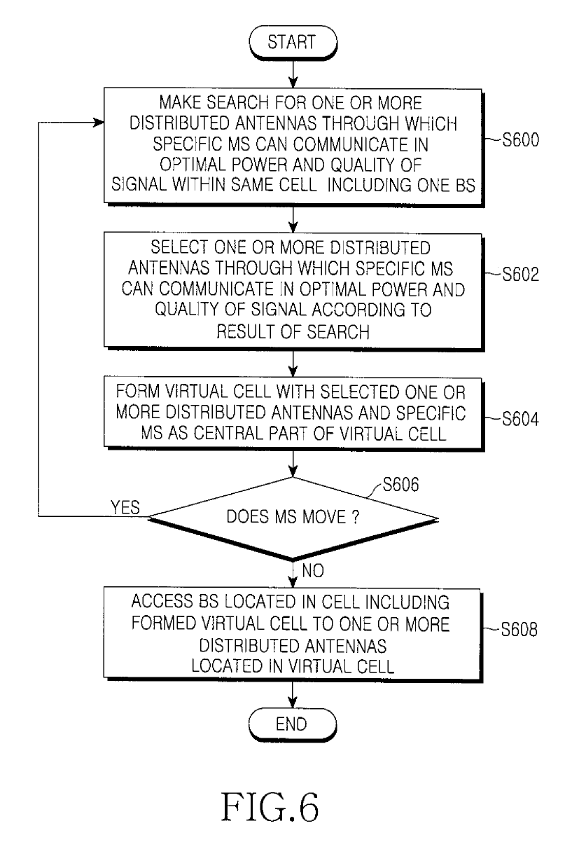

FIG. 6 is a flowchart illustrating an example of a method for forming a virtual cell by using one or more distributed antennas in a WiMAX mobile communication system according to the present invention.

First, in step S600, in order to gain access to a network system when a user requests a user MS to connect a call, or according to channel conditions, the user MS makes a search for one or more distributed antennas through which the user MS can communicate in a preset service quality within the same cell including one BS.

After the search, the user MS selects, in step S602, one or more distributed antennas through which a specific user MS can communicate in a preset service quality according to a result of the search.

Next, in step S604, a virtual cell is formed with the selected one or more distributed antennas and the specific user MS as the central part of the virtual cell. Herein, the virtual cell corresponds to one or more cells included in a single cell including the BS and multiple MSes located in the range over which communication control can be implemented.

In step 606 if the MS has moved, the method reverts back to step S600 and makes another search, so as to ensure the quality of service does not change as the user MS changes location.

In step 608, a BS located in a cell including the virtual cell formed in step 604 gains access to one or more distributed antennas located in the virtual cell, and performs communications via the one or more distributed antennas.

The merits and effects of exemplary embodiments, as disclosed in the present invention, and as so configured to operate as shown above, will be described as follows.

As previously described, according to the present invention, by proposing a virtual cell based on the distributed antennas with a specific MS as the central part of the virtual cell, stable communications are performed without handover between the antennas belonging to the same BS, and a space possessed by antennas is not only small in an overall network system but also it can increase communication capacity and a data transfer rate. In addition, since an average access distance between a user MS and an antenna becomes shorter, transmission output power of the user MS is reduced.

While the invention has been shown and described with reference to certain exemplary embodiments thereof, it will be understood by those skilled in the art that various changes in form and details may be made therein without departing from the spirit of the invention and the scope of the appended claims.

What is claimed is:

1. A system for forming a cell by using distributed antennas in a World interoperability for Microwave Access (WiMAX) mobile communication system supporting broadband wireless access, the system comprising:
a plurality of Mobile Stations (MSes);
distributed antennas for performing simultaneous communications with at least one MS among the plurality of MSes, and for forming one virtual cell by communicating with said at least one MS among the plurality of MSes; and
a Base Station (BS), connected to the distributed antennas for communicating with at least said one MS of the plurality of MSes.

2. The system according to claim 1, wherein the BS is connected to the distributed antennas by optical fibers.

3. The system according to claim 1, where the plurality of MSes are located with a cell, and a virtual cell comprises an area within the cell.

4. The system according to claim 1, wherein the number of virtual cells corresponds to the number of MSes of said plurality of MSes.

5. The system according to claim 1, wherein each MS of the plurality of MSes communicates with one or more distributed antennas with a signal power greater than a preset reference value.

6. The system according to claim 5, wherein each MS of the plurality of MSes communicates with one or more distributed antennas according to a preset service quality.

7. The system according to claim 1 wherein each MS of the plurality of MSes communicates with one or more distributed antennas according to a preset service quality.

8. The system according to claim 1, wherein the distributed antennas comprise a transceiver for performing conversion between a Radio Frequency (RF) signal and a digital Intermediate Frequency (IF) signal.

9. The system according to claim 1, wherein the BS performs signal processing of a transmitted digital Intermediate Frequency (IF) signal.

10. The system according to claim 1, wherein the number of distributed antennas and positions thereof are adjusted according to the number of MSes of users within the cell and channel conditions.

11. The system according to claim 4, wherein the number of distributed antennas and positions thereof are adjusted according to the number of MSes of users within the cell and channel conditions.

12. The system according to claim 1, wherein the WiMAX mobile communication system is based on the Institute of Electrical and Electronics Engineers (IEEE) 802.16e Wireless Metropolitan Area Network (WMAN) standards.

13. The system according to claim 2, wherein the WiMAX mobile communication system is based on the Institute of Electrical and Electronics Engineers (IEEE) 802.16e Wireless Metropolitan Area Network (WMAN) standards.

14. The system according to claim 1, wherein the WiMAX mobile communication system corresponds to a scheme of Point-to-MultiPoint (PMP).

15. The system according to claim 4, wherein the virtual cell is formed with a specific MS as a central part of the virtual cell.

16. A method for forming a cell by using distributed antennas in a World interoperability for Microwave Access (WiMAX) mobile communication system supporting broadband wireless access communication system, the method comprising the steps of:
making a search, by a Mobile Station (MS), for one or more distributed antennas satisfying a preset service quality in the same cell including one Base Station (BS);
selecting one or more distributed antennas satisfying the service quality according to a result of the search;
forming a virtual cell with the selected one or more distributed antennas; and
accessing a BS located in a cell including the formed virtual cell by one or more distributed antennas located in the virtual cell, and performing communications therebetween.

17. The method according to claim 16, wherein a number of distributed antennas and positions thereof are adjusted according to a number of MSes within the cell.

18. The method according to claim 17, wherein the step in which the number of distributed antennas and positions thereof are adjusted is also based on the channel conditions.

19. The method according to claim 16, wherein the virtual cell is formed with a specific MS as a central part of the virtual cell.

20. The method according to claim 10, wherein the broadband wireless access communication system is based on Institute of Electrical and Electronics Engineers (IEEE) 802.16e Wireless Metropolitan Area Network (WMAN) standards.
